(19) United States
(12) Patent Application Publication
(10) Pub. No.: US 2025/0002371 A1
(43) Pub. Date: Jan. 2, 2025

(54) METHOD OF MANUFACTURING COBALT-FREE NICKEL-RICH CATHODE MATERIALS FOR LITHIUM-ION BATTERIES

(71) Applicant: UT-Battelle, LLC, Oak Ridge, TN (US)

(72) Inventors: Ilias Belharouak, Knoxville, TN (US); Marm B. Dixit, Oak Ridge, TN (US); Rachid Essehli, Knoxville, TN (US); Nitin Muralidharan, Knoxville, TN (US)

(21) Appl. No.: 18/756,539

(22) Filed: Jun. 27, 2024

Related U.S. Application Data
(60) Provisional application No. 63/523,385, filed on Jun. 27, 2023.

(51) Int. Cl. C01G 53/00; C01G 53/04; H01M 4/02; H01M 4/525; H01M 10/0525

(52) U.S. Cl. CPC C01G 53/50; C01G 53/04; H01M 4/525; H01M 10/0525; C01P 2002/52; C01P 2002/72; C01P 2004/03; C01P 2006/40; H01M 2004/028

(57) ABSTRACT

A method of forming a cathode material precursor is provided. The method is an ethanol-assisted, hydrothermal synthesis and includes dissolving a nickel nitrate hydrate in ethanol to obtain a first mixture. The first mixture is then heated at a first temperature for a first period of time. Subsequently, the first mixture is cooled, filtered, washed, and dried to obtain a nickel hydroxide hydrate precipitate that is the cathode material precursor. In the method, the first mixture is free of ammonia. The cathode material precursor obtained may be α-3Ni(OH)₂·2H₂O. A method of forming a cobalt-free, nickel-rich cathode material from the cathode material precursor is also provided. The resulting cathode material may be LiNi_{0.9}Mn_{0.05}Al_{0.05} O₂ (NMA9055).

### CROSS-REFERENCE TO RELATED APPLICATIONS

This application claims the benefit of U.S. Provisional Application No. 63/523,385, filed Jun. 27, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of manufacturing cathode materials for lithium-ion batteries and other applications.

### BACKGROUND OF THE INVENTION

The rapidly rising electric vehicle (EV) market may reach a critical growth limit as a result of relying on conventional cathode materials like NMCs (LiNiₓMn_{y}Co_{z}O₂) or NCAs (LiNi_{0.8}Co_{0.15}Al_{0.05} O₂). Even though these materials can deliver high capacities (˜200 mAh/g), they suffer from voltage drop and thermal instability despite having high cobalt content in their compositions. Moreover, materials such as NCAs which are considered to be instrumental in next generation battery technology, inherently suffer from uneven distribution of aluminum (Al) elements caused by limitations of solid-phase diffusion and surface passivation phenomenon leading to deterioration of electrochemical performance.

The rising demand for EVs introduces high demand stresses on nickel (Ni), manganese (Mn), as well as cobalt (Co) minerals as necessary raw materials for NMC and NCA cathodes. Co is a key concern due to the challenges associated with its mining. Resource availability of critical materials may significantly impact the long-term market stability and techno-economics of EVs. For example, a single EV battery pack (˜75 kWh) requires close to 2 kT of Co material for NMC-type cathodes which may lead to resource scarcity in the near future. Therefore, transitioning to Co-free cathode materials may have numerous technological advantages over and above the economic and socio-political advantages of stabilized resource prices and reduced sociological impact, thus enabling a sustainable battery market. Further, a high Ni concentration is necessary in cathode materials for achieving the high driving ranges required for EV applications. However, high Ni containing electrode materials continue to suffer from several technological challenges. A key operational bottleneck is the formation of surface passivation layers that limit the electrochemical performance of the batteries, for example decomposition of Li₂O in air to form Li₂CO₃ which is responsible for gassing and swelling issues via O₂ and CO₂ evolution, and formation of LiOH which causes slurry gelation during processing.

In present day battery material manufacturing, co-precipitation in a Continuous Stirred Tank Reactor (CSTR) is the most commonly adopted method to synthesize battery cathode precursors in their hydroxide forms. These hydroxide precursors are synthesized using ammonia (NH₃·H₂O) as chelating agents to control the morphology and particle size during the co-precipitation process. However, the use of large quantities of ammonia and ammonia containing solutions not only leads to increased production cost but also requires enormous quantities of water for product washing and filtration that end up as waste product. Furthermore, the entire process of handling and separating ammonia is environmentally hazardous leading to toxic waste generation. Additionally, when considering the specific case of a NCA co-precipitation process, the large difference in solubility product constants of Ni²⁺, Co²⁺, and Al³⁺ leads to the precursors suffering from large compositional inhomogeneities and morphological issues such as being non-spherical with low tap densities. Therefore, a need exists for improved cathode materials having one or more of good monodispersed spherical morphologies, excellent compositional control, and high tap densities, as well as improved methods of manufacturing cathode materials.

### SUMMARY OF THE INVENTION

A method of forming a cathode material precursor is provided. The method includes dissolving a nickel nitrate hydrate in ethanol to obtain a first mixture; heating the first mixture at a first temperature for a first period of time; and cooling the first mixture to obtain a nickel hydroxide hydrate precipitate that is the cathode material precursor. In the method, the first mixture is free of ammonia.

In specific embodiments, the method further includes filtering the cooled first mixture to isolate the nickel hydroxide hydrate precipitate.

In specific embodiments, the nickel nitrate hydrate is nickel (II) nitrate hexahydrate.

In specific embodiments, the cathode material precursor is α-3Ni(OH)₂·2H₂O.

In specific embodiments, the step of heating the first mixture is performed in an autoclave.

In specific embodiments, the first temperature is in a range of 160° C. and 200° C.

In specific embodiments, the first period of time is at least 18 hours.

A method of forming a cobalt-free, nickel-rich cathode material for a lithium-ion battery is also provided. In some embodiments, the method includes dissolving a lithium precursor, an aluminum precursor, and a manganese precursor in ethanol to obtain a second mixture; adding the cathode material precursor formed by the method above to the second mixture to obtain a third mixture; stirring the third mixture at a second temperature for a second period of time to evaporate the ethanol and to obtain a first powder; heating the first powder at a third temperature for a third period of time to obtain a second powder; and heating the second powder at a fourth temperature for a fourth period of time to obtain a third powder that is a lithium-bearing metal oxide.

In specific embodiments, the aluminum precursor and the manganese precursor are nitrate precursors.

In specific embodiments, the lithium precursor is a hydroxide precursor.

In specific embodiments, the method further includes one of: i) grinding the first powder prior to heating the first powder; ii) grinding the second powder prior to heating the second powder; or iii) both i) and ii).

In specific embodiments, the fourth temperature is greater than the third temperature.

In specific embodiments, the fourth period of time is greater than the third period of time.

In specific embodiments, the second temperature is in a range of 35° C. and 45° C.

In specific embodiments, the third powder is LiNi_{0.9}Mn_{0.05}Al_{0.05} O₂.

In other embodiments, a method of forming a cobalt-free, nickel-rich cathode material for a lithium-ion battery includes ethanol-assisted, hydrothermal synthesis of a cathode precursor by ethanol oxidation without the presence of ammonia, the hydrothermal synthesis including: dissolving nickel (II) nitrate hexahydrate in ethanol to obtain a first solution; heating the first solution at a first temperature for a first period of time; cooling the first solution; and filtering the cooled solution to obtain the cathode material precursor that is α-3Ni(OH)₂·2H₂O. Subsequent to synthesizing the cathode material precursor, the method further includes performing synthesis of a lithium-bearing metal oxide, the synthesis including: dissolving LiOH·H₂O, Al(NO₃)₃·9H₂O, and Mn(NO₃)₃·9H₂O in ethanol to obtain a second solution; adding the α-3Ni(OH)₂·2H₂O cathode material to the second solution to obtain a third solution; stirring the third solution at a second temperature for a second period of time to obtain a first powder; grinding the first powder followed by heating the first powder at a third temperature for a third period of time to obtain a second powder; and grinding the second powder followed by annealing the second powder at a fourth temperature for a fourth period of time to obtain the lithium-bearing metal oxide powder.

In specific embodiments, the lithium-bearing metal oxide powder is LiNi_{0.9}Mn_{0.05}Al_{0.05} O₂.

A cobalt-free, nickel-rich cathode material formed by the methods above, and a lithium-ion battery including the cobalt-free, nickel-rich cathode material are also provided.

These and other features of the invention will be more fully understood and appreciated by reference to the description of the embodiments and the drawings.

### BRIEF DESCRIPTION OF THE DRAWINGS

FIG. 1 is a flow diagram of a method of forming a cathode material precursor and a cobalt-free, nickel-rich cathode material in accordance with embodiments of the disclosure;

FIG. 2 is an X-ray diffraction (XRD) spectrum of a cathode material precursor formed by the method;

FIG. 3 is a graph of in situ XRD spectra of a cobalt-free, nickel-rich cathode material formed by the method that is heated between 30° C. and 800° C. and cooled between 800° C. and 30° C.;

FIG. 4 is an enlarged portion of the graph of FIG. 3;

FIG. 5 is another enlarged portion of the graph of FIG. 3;

FIG. 6 is yet another enlarged portion of the graph of FIG. 3;

FIG. 7 is a graph of ex-situ XRD spectra of the cobalt-free, nickel-rich cathode material between 3.7 V and 4.5 V;

FIG. 8 is an enlarged portion of the graph of FIG. 7;

FIG. 9 is another enlarged portion of the graph of FIG. 7;

FIG. 10 depicts two scanning electron micrographs (SEM) of the cathode material precursor;

FIG. 11 depicts a SEM of the cobalt-free, nickel-rich cathode material;

FIG. 12 is a graph of a cycling voltammogram (CV) of the cobalt-free, nickel-rich cathode material at a 0.05 mV/s scan rate for a voltage limit between 3.0 V and 4.3 V;

FIG. 13 is a graph of a CV of the cobalt-free, nickel-rich cathode material at a 0.05 mV/s scan rate for a voltage limit between 3.0 V and 4.4 V;

FIG. 14 is a graph of a CV of the cobalt-free, nickel-rich cathode material at a 0.05 mV/s scan rate for a voltage limit between 3.0 V and 4.5 V;

FIG. 15 is a graph of a CV of the cobalt-free, nickel-rich cathode material at scan rates of 0.05 mV/s, 0.10 mV/s, 0.25 mV/s, 0.50 mV/s, 0.75 mV/s, and 1.00 mV/s for a voltage limit between 3.0 V and 4.3 V;

FIG. 16 is a graph of a CV of the cobalt-free, nickel-rich cathode material at scan rates of 0.05 mV/s, 0.10 mV/s, 0.25 mV/s, 0.50 mV/s, 0.75 mV/s, and 1.00 mV/s for a voltage limit between 3.0 V and 4.4 V;

FIG. 17 is a graph of a CV of the cobalt-free, nickel-rich cathode material at scan rates of 0.05 mV/s, 0.10 mV/s, 0.25 mV/s, 0.50 mV/s, 0.75 mV/s, and 1.00 mV/s for a voltage limit between 3.0 V and 4.5 V;

FIG. 18 is a graph of galvanostatic charge-discharge profiles of half cells including the cobalt-free, nickel-rich cathode material at a 0.3 C rate and between a voltage window of 3.0 V and 4.3 V at room temperature;

FIG. 19 is a graph of galvanostatic charge-discharge profiles of half cells including the cobalt-free, nickel-rich cathode material at a 0.3 C rate and between a voltage window of 3.0 V and 4.4 V at room temperature;

FIG. 20 is a graph of galvanostatic charge-discharge profiles of half cells including the cobalt-free, nickel-rich cathode material at a 0.3 C rate and between a voltage window of 3.0 V and 4.5 V at room temperature;

FIG. 21 is a graph of cycle rate performance of half cells including the cobalt-free, nickel-rich cathode material at 0.1 C, 0.2 C, 0.3 C, 0.5 C, and 1 C rates between a voltage of 3.0 V and 4.5 V;

FIG. 22 is a graph of long-term cycling of half cells including the cobalt-free, nickel-rich cathode material at a 0.3 C rate between a voltage of 3.0 V and 4.3 V, 3.0 V and 4.4 V, and 3.0 V and 4.5 V;

FIG. 23 is a graph of galvanostatic charge-discharge profiles of half cells including the cobalt-free, nickel-rich cathode material at a 0.3 C rate and between a voltage window of 3.0 V and 4.4 V and a temperature of 50° C.;

FIG. 24 is a graph of a comparison of long-term cycling performance of half cells including the cobalt-free, nickel-rich cathode material at a 0.3 C rate between a voltage of 3.0 V and 4.4 V at room temperature and 50° C.;

FIG. 25 is a graph of galvanostatic charge-discharge profiles of full cells including the cobalt-free, nickel-rich cathode material and Li₄Ti₅O₁₂ (LTO) at C/3 and between a voltage of 0.2 V and 3.5 V; and

FIG. 26 is a graph of long-term cycling performance of full cells including the cobalt-free, nickel-rich cathode material and Li₄Ti₅O₁₂ (LTO) at C/3 and between a voltage of 0.2 V and 3.5 V.

### DETAILED DESCRIPTION OF THE CURRENT EMBODIMENTS

As discussed herein, the current embodiments relate to a method of forming a cathode material precursor and a cobalt-free, nickel-rich cathode material for a lithium-ion battery. The method provides a hydro/solvothermal synthesis route to generate high quality battery cathode precursors with monodispersed spherical morphologies and sufficient compositional control to enable high performance battery cathode materials. The synthesis route also has the benefit of being a completely ammonia-free co-precipitation process. The precursors synthesized through the method have high tap densities which can significantly increase the active material loading in battery electrodes. As a result, a sizeable reduction in the number of electrode layers in the battery cell can be achieved leading to cost savings.

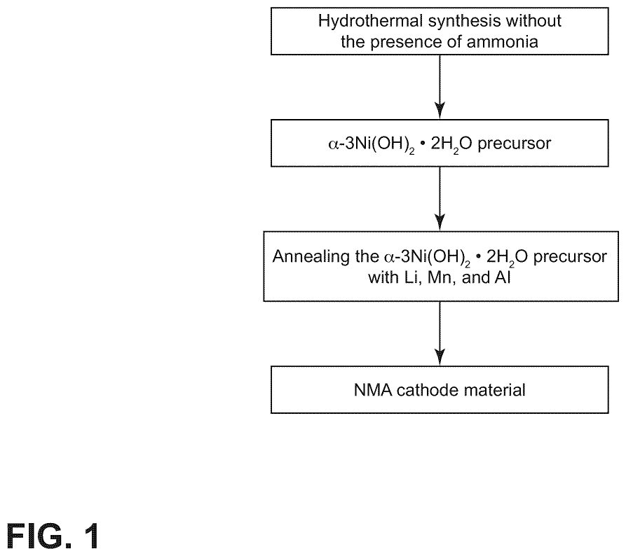

With reference to FIG. 1, the method of forming the cathode material precursor is an ethanol-assisted, hydrothermal synthesis method that does not require the presence of ammonia and is therefore free of ammonia. The method first includes dissolving a nickel nitrate hydrate in ethanol to obtain a first mixture that is a solution of the nickel nitrate hydrate in the ethanol solvent. Again, no ammonia is included in the first mixture. In various embodiments, the nickel nitrate hydrate is nickel (II) nitrate hexahydrate, but other nitrates may be used. The method next includes heating the first mixture at a first temperature for a first period of time. The first temperature may be in a range of 160° C. and 200° C., optionally in a range of 170° C. and 190° C., optionally in a range of 175° C. and 185° C. In some embodiments, the first temperature is approximately 180° C. This low reaction temperature limits the formation of unfavorable side products (such as oxide impurities) and reduces the cost of the process. Additionally, the process facilitates favorable crystallinity and narrow particle size distributions that are crucial for high performance battery materials. The first period of time may be at least 18 hours, optionally at least 20 hours, optionally at least 22 hours, optionally at least 24 hours. In some embodiments, the first period of time is approximately 24 hours. Further, the heating of the first mixture may be performed in an autoclave. After the heating step, the first mixture is allowed to cool naturally to room temperature. A nickel hydroxide hydrate precipitate is obtained after cooling, the nickel hydroxide hydrate being the cathode material precursor. The cooled first mixture including the nickel hydroxide hydrate precipitate may be filtered and washed one or more times to isolate the nickel hydroxide hydrate. Additionally, after filtration and washing, the nickel hydroxide hydrate may be dried under vacuum at an elevated temperature for a period of time such as 8 to 16 hours.

In various embodiments, the nickel hydroxide hydrate obtained is α-3Ni(OH)₂·2H₂O. In this method, α-3Ni(OH)₂·2H₂O particles are precipitated in the presence of hydroxide ions (OH⁻) generated from the oxidation of absolute ethanol (CH₃CH₂OH) via thermal decomposition to acetaldehyde (C₂H₄O), by the following Reaction (1).

7CH₃CH₂OH+4NO₃⁻→7CH₃CHO+2NO↑+N₂O↑+4OH⁻+5H₂O (1)

Subsequently, the α-3Ni(OH)₂·2H₂O is precipitated in the presence of the hydroxide ions, by the following Reaction 2.

3Ni²+2H₂O+6OH⁻→3Ni(OH)₂·2H₂O (2)

Next, the cathode material precursor obtained from the hydrothermal synthesis is used to synthesize a lithium-bearing metal oxide that is a cobalt-free, nickel-rich cathode material that can be used in a lithium-ion battery. This synthesis method includes dissolving a lithium precursor, an aluminum precursor, and a manganese precursor in ethanol to obtain a second mixture that is a solution of these precursors in ethanol as the solvent. In some embodiments, the aluminum precursor and the manganese precursor are nitrate precursors. Nitrate precursors for aluminum and manganese are soluble in ethanol, whereas their hydroxide or sulfate versions are not miscible with ethanol. In certain embodiments, the aluminum precursor is Al(NO₃)₃·9H₂O and the manganese precursor is Mn(NO₃)₃·9H₂O. In some embodiments, the lithium precursor is a hydroxide precursor. In certain embodiments, the lithium precursor is LiOH·H₂O. Further, the (nickel) cathode material precursor formed by the hydrothermal method above is added to the second mixture to obtain a third mixture that is an ethanol solution of all the precursors. Subsequently, the third mixture is stirred at a second temperature for a second period of time to obtain a first powder. The second temperature may be in a range of 35° C. to 45° C., optionally in a range of 37.5° C. to 42.5° C. In some embodiments, the second temperature may be approximately 40° C. The second period of time may be at least 30 minutes, optionally at least 1 hour, optionally at least 1.5 hours, optionally at least 2 hours. In some embodiments, the second period of time is approximately 2 hours. The second period of time should be long enough to evaporate the ethanol and to obtain a powder. The first powder can then be ground, followed by heating at a third temperature for a third period of time to obtain a second powder. This heat treatment may be performed in a furnace or similar, and in ambient air, in order to decompose the precursors and to remove water and ammonia generated during the decomposition. The third temperature may be in a range of 400° C. to 600° C., optionally in a range of 425° C. to 575° C., optionally in a range of 450° C. to 550° C., optionally in a range of 475° C. to 525° C. In some embodiments, the third temperature is approximately 500° C. The third period of time may be at least 6 hours, optionally at least 8 hours, optionally at least 10 hours, optionally at least 12 hours. In some embodiments, the third period of time may be approximately 12 hours. The second powder can then be ground, followed by annealing by heating at a fourth temperature for a fourth period of time to obtain a third powder that is a lithium-bearing metal oxide constituting the cobalt-free, nickel-rich cathode material. The fourth temperature may be in a range of 650° C. to 850° C., optionally in a range of 675° C. to 825° C., optionally in a range of 700° C. to 800° C., optionally in a range of 725° C. to 775° C. As such the fourth temperature for annealing is higher than the third temperature used to heat the powder. In some embodiments, the third temperature is approximately 750° C. The third period of time may be at least 14 hours, optionally at least 16 hours, optionally at least 18 hours, optionally at least 20 hours. In some embodiments, the third period of time may be approximately 20 hours. As such, the fourth period of time for annealing the powder may be longer than the third period of time for heating/decomposing the precursors. The third powder is the final product and may have the chemical formula LiNi_{0.9}Mn_{0.05}Al_{0.05} O₂(NMA9055) depending upon the molar ratio of the precursor components.

### EXAMPLE

The method is further described in connection with the following laboratory example, which is intended to be non-limiting.

α-3Ni(OH)₂·2H₂O microsphere precursors were prepared by an ethanol-assisted hydrothermal method. 10 g of nickel (II) nitrate hexahydrate (Ni(NO₃)₂·6H₂O) was dissolved in 100 ml absolute ethanol at room temperature to obtain a clear solution. The resulting solution was transferred to an autoclave (250 ml capacity), and then heated at 180° C. for 24 hours followed by natural cooling to room temperature. After the hydrothermal treatment, a green powder of α-3Ni(OH)₂·2H₂O was obtained via filtration and several washing cycles followed by drying under vacuum at 80° C. for a period of 12 hours. To prepare LiNi_{0.9}Mn_{0.05}Al_{0.05} O₂(NMA9055) cathode material, LiOH·H₂O (Sigma-Aldrich), Al(NO₃)₃·9H₂O (Sigma-Aldrich), and Mn(NO₃)₃·9H₂O (Sigma-Aldrich) (molar ratio of Li:(Ni+Mn+Al)=1.02:1 where Ni:Mn:Al=9:0.5:0.5) were dissolved in 10 ml of absolute ethanol to form a clear solution. Nitrate precursors were used for the manganese and aluminum as these salts are soluble in ethanol. In comparison, their hydroxide or sulfate versions are not miscible with ethanol and thus were not utilized. The Ni(OH)₂·2H₂O microsphere precursor that was prepared via the hydrothermal synthesis route was added to the solution and stirred for 2 hours at 40° C. to evaporate the ethanol. The obtained powder was ground and heated at 500° C. for 12 hours in ambient air to decompose the precursors and to remove H₂O and NH₃. The resultant black powder was ground again and annealed at 750° C. under a O₂ atmosphere for 20 hours to obtain the final cathode powder, LiNi_{0.9}Mn_{0.05}Al_{0.05} O₂(NMA9055).

Li₄Ti₅O₁₂ (LTO) was synthesized via a hydrothermal assisted sol-gel method. Stoichiometric amounts of titanium (IV) butoxide and LiOH·H₂O were dissolved in 20 ml ethanol and stirred for 2 hours. The resulting solution was transferred to an autoclave (250 ml capacity), which was then heated at 180° C. for 24 hours followed by natural cooling to room temperature. A white powder was then obtained after filtration and several washing cycles. The resultant powder was ground and annealed at 650° C. in ambient air for 12 hours to obtain the final LTO powder.

X-ray diffraction (XRD) was performed on the synthesized α-3Ni(OH)₂·2H₂O precursor, NMA cathode and LTO anode materials using a Panalytical Xpert Pro instrument. The XRD patterns were collected at room temperature for the α-3Ni(OH)₂·2H₂O precursor, NMA and LTO materials using a Bruker D8 ADVANCE diffractometer operating with Cu—Kα radiation. The full pattern-matching refinements were performed using the Jana2006 program package. The backgrounds were estimated by a Legendre function, and the peak shapes were described by a pseudo-Voigt function.

Neutron diffraction data was collected at the NOMAD beamline at SNS, Oak Ridge National Laboratory. About a 0.3 g powder sample was loaded into a thin-walled quartz capillary with a diameter of 3 mm. Four 24-minute scans were collected and summed together to improve the statistics. The collected data were background subtracted (four 24-minute scans of empty 3 mm quartz capillary) and normalized against a vanadium rod. Rietveld refinement was carried out using TOPAS version 6. During the structure refinement, lattice parameters, z-coordinate of oxygen and isotropic atomic displacements were allowed to be refined. The occupancies were constrained in the following way: Ni and Mn were fixed by the chemical stoichiometry, Ni and Li were allowed to form anti-site defects, i.e., the amount of displaced Ni²⁺ in the lithium layer was forced to be the amount of Li displaced into the lithium layer.

Half cells with Li metal as the anode and NMA as the cathode were assembled in coin cells. After cycling, the cells were disassembled in a glove box, and the cathodes were delaminated and rinsed in DMC solvent several times. The cathode was scraped from the current collector and the powder was used for XRD measurements. A commercial El-Cell operando electrochemical cell was used with a Li foil (Ø=10 mm) placed on a stainless-steel disc, a glass fiber as the separator, and an electrode coated Al mesh that allowed for contact with the positive pin that was connected to the potentiostat. The slurry was casted onto the Al mesh that also acted as the current collector. The electrode was then dried in a vacuum oven overnight to remove the solvent. The El-cell was sealed with a 200 μm thick Be window, along with an O-ring seal to prevent air ingress.

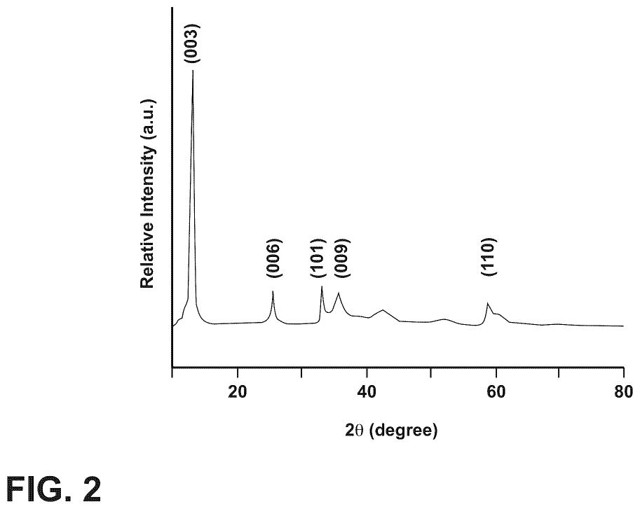

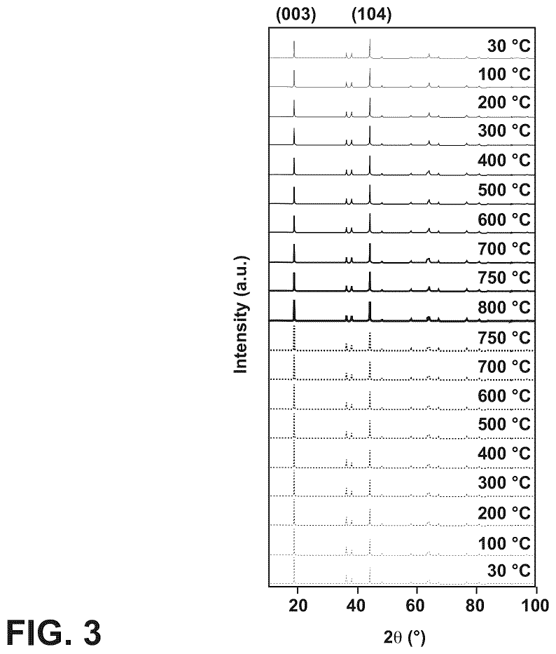

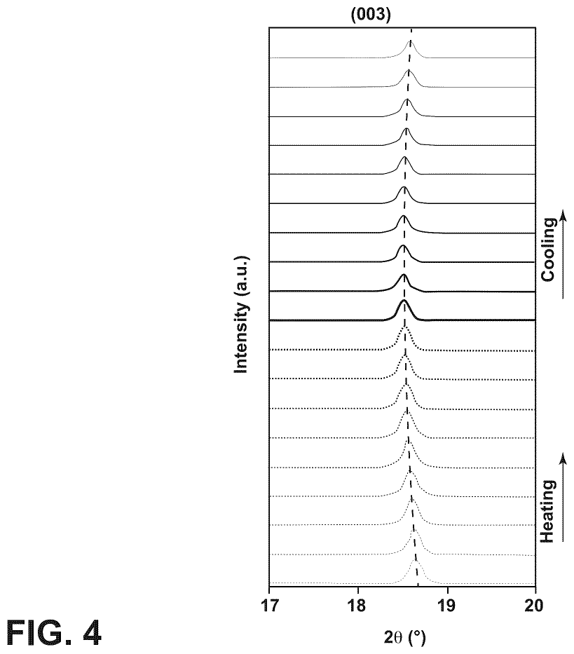

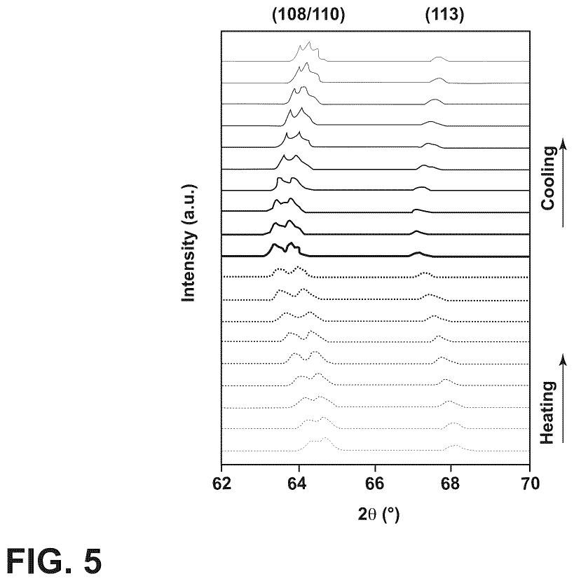

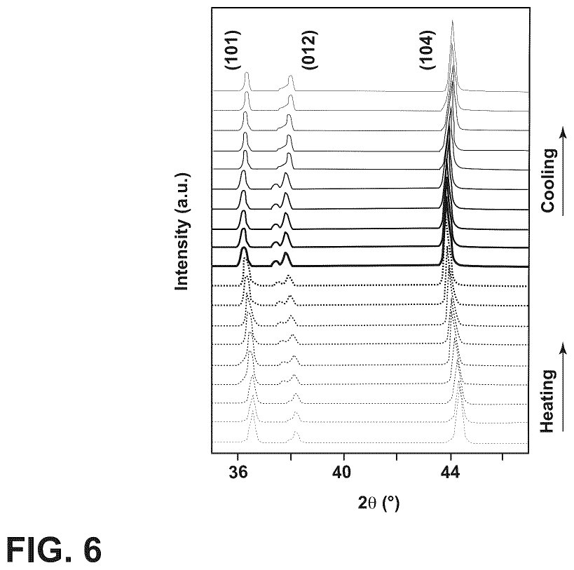

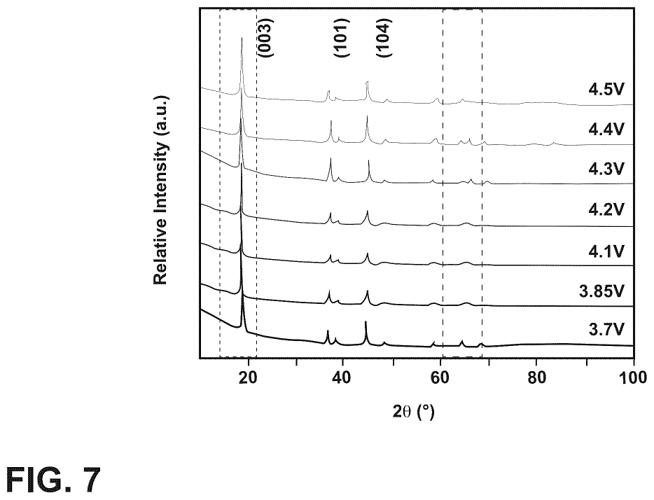

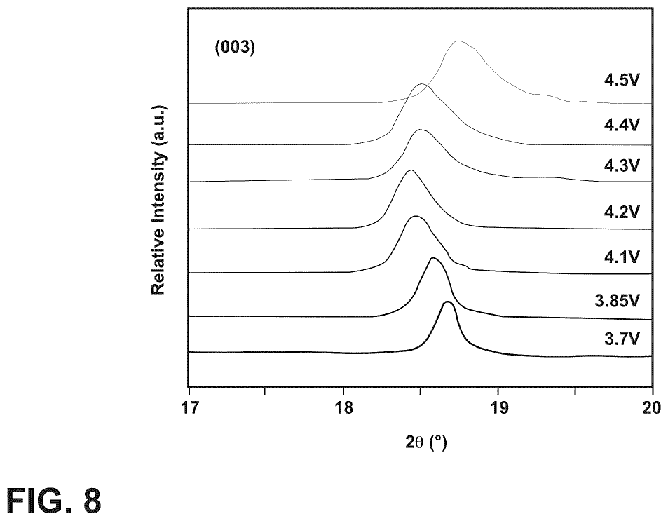

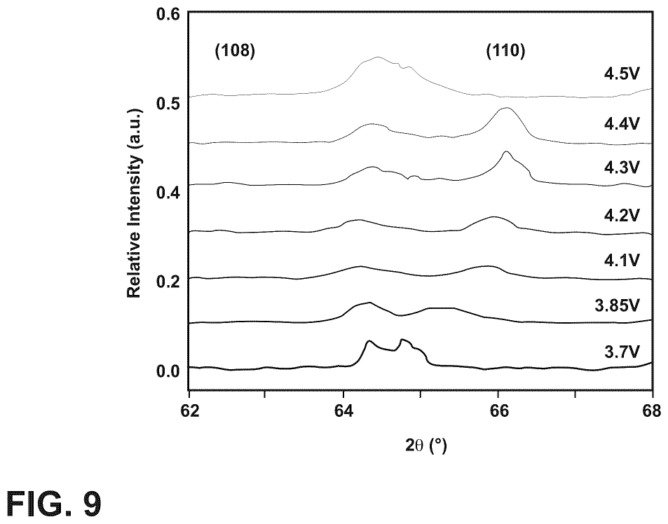

The XRD spectra and fitting by Rietveld refinement for the α-3Ni(OH)₂·2H₂O precursor is shown in FIG. 2. The pattern shows a pure phase nickel hydroxide similar to α-3Ni(OH)₂. In situ XRD patterns collected during a thermal stability study between 30° C. and 800° C. for the NMA9055 cathode material are shown in FIGS. 3-6. During heating, no impurity phases or phase changing were observed in the XRD patterns of NMA9055. The heating of NMA9055 at elevated temperature around 800° C. did not alter the layered structure, which means Mn and Al have been shown to effectively stabilize the layered structure with hexagonal (R-3m) space group. During cooling, no impurity phases were observed. Full ex-situ XRD spectra of the NMA9055 cathode from 3.7 V to 4.5 V are shown in FIGS. 7-9. The cathodes were charged to different SOC between 3.7 V and 4.5 V, the cells then dissembled, and XRD measurements were conducted on the electrodes. During charging, the (003) reflection shifted to considerably lower angles, which can be attributed to the larger variation of the c parameter. Beyond 4.2 V, the (003) reflection monotonically shifted to higher angles from 4.3 V to 4.5 V which can be attributed to a shrinking c parameter.

Morphological characterization of the α-3Ni(OH)₂·2H₂O precursor, NMA cathode, and LTO anode materials were performed using a Scanning Electron Microscope (SEM, Zeiss Merlin system). Energy Dispersive Spectroscopy of the materials was carried out at a 20 kV beam energy. The composition of the synthesized powders was determined by Inductively Coupled Plasma Optical Emission Spectrometer (ICP-OES, Agilent Technologies 5110). The samples were digested in an HF solution and then diluted in 2 wt % HNO₃ for ICP measurements.

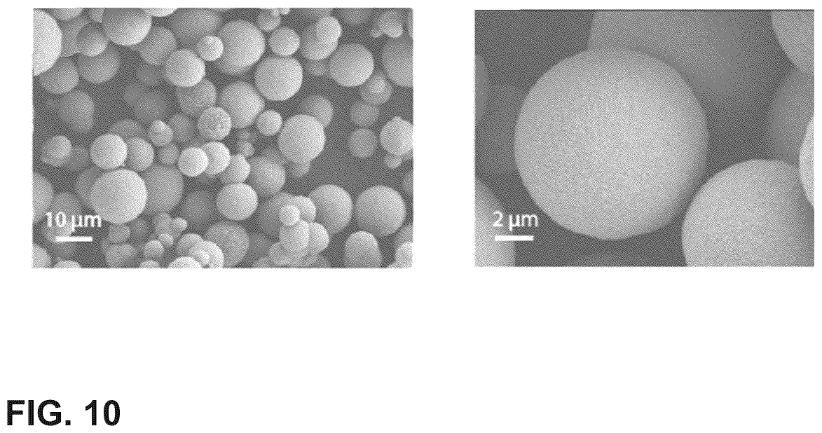

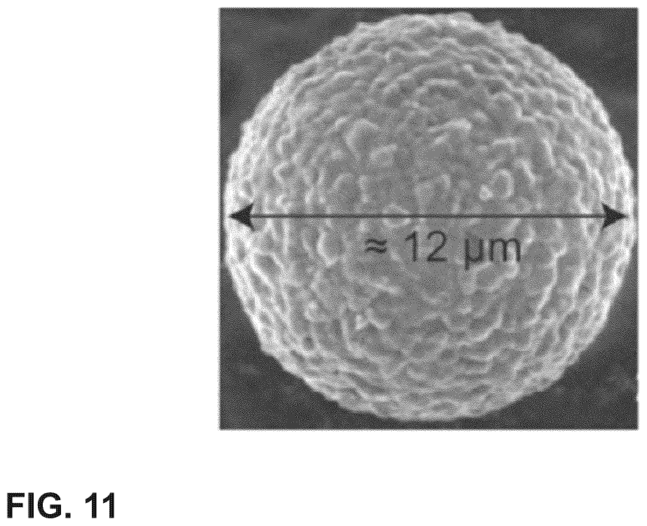

The SEM images of the α-3Ni(OH)₂·2H₂O precursor at two different magnifications are shown in FIG. 10. These SEM images indicated that the precursor has a monodispersed spherical morphology with an average particle size of approximately 11 μm. The SEM micrographs show that high-quality monodispersed hydroxide precursors are successfully precipitated using the method disclosed herein using ethanol oxidation in the presence of (NO₃)⁻ at 180° C. without the presence of ammonia. The SEM micrograph of the NMA9055 cathode is shown in FIG. 11 and shows that the NMA9055 cathode material retains the spherical morphology of the precursors. The particle size of the NMA9055 cathode material is approximately 12 μm.

NMA powder, carbon black (power grade, denka) and polyvinylidene fluoride (PVDF, solvay 5130) were used for cathode slurry preparation with N-Methyl-pyrolidine (NMP) solvent. The NMA cathode consisted of 80 wt. % NMA, 10 wt. % carbon black and 10 wt. % PVDF. The resulting electrode coatings were cut into round discs (Φ=13 mm) and dried at 120° C. for 12 hours under vacuum. CR2032 coin cells with lithium foil, Celgard 2325 separator, Gen 2 electrolyte (1.2 M LiPF₆ in 3/7 EC/EMC by weight) and NMA cathode were assembled inside a glovebox. The cathode loading was 3 mg·cm⁻² unless noted otherwise. The assembled coin cells were electrochemically evaluated via cyclic voltammetry for evaluation of redox potentials. Cell capacities were analyzed using galvanostatic charge/discharge tests. Potentiostatic EIS measurements and Galvanostatic Intermittent Titration Technique (GITT) measurements were carried out to evaluate the cell resistance at fully charged and discharged states and to determine lithium diffusion coefficients, respectively. In brief, in-situ electrochemical impedance spectroscopy (EIS) measurements were performed to determine the various cell resistance components (interfacial charge transfer and electrolyte resistances) as a function of state of charge (SOC) and state of discharge (SOD). First, the cell was cycled to form a stable solid electrolyte interphase (SEI), and then a current equivalent to a C/10 rate was applied to charge/discharge using a BioLogic VSP testing station. DC current was switched on for 1 hour to charge/discharge the cell, followed by 2 hours rest to reach a steady-state cell voltage. The measurement procedure was repeated stepwise for covering all SOC/SOD. The EIS was performed in the frequency range of 1 MHz to 1 Hz using a sinusoidal voltage amplitude of 10 mV at steady state OCV conditions. The EIS spectra were fitted using an equivalent circuit model built in ZView software. All the electrochemical testing was performed using a BioLogic potentiostat. Full cell evaluations were carried out with an LTO anode.

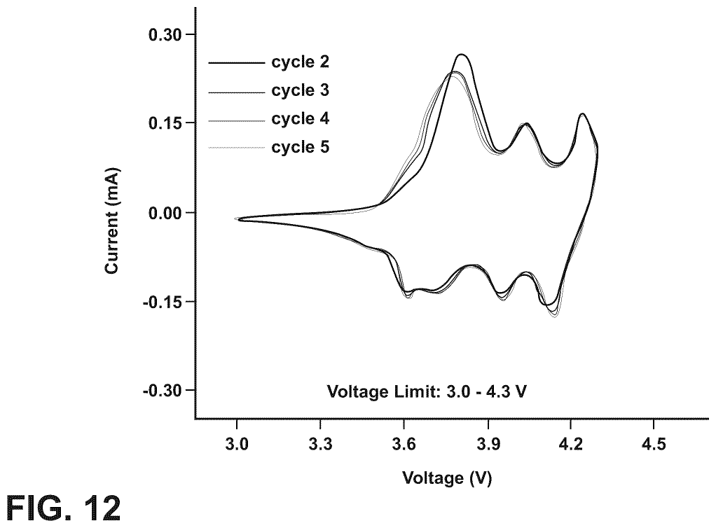

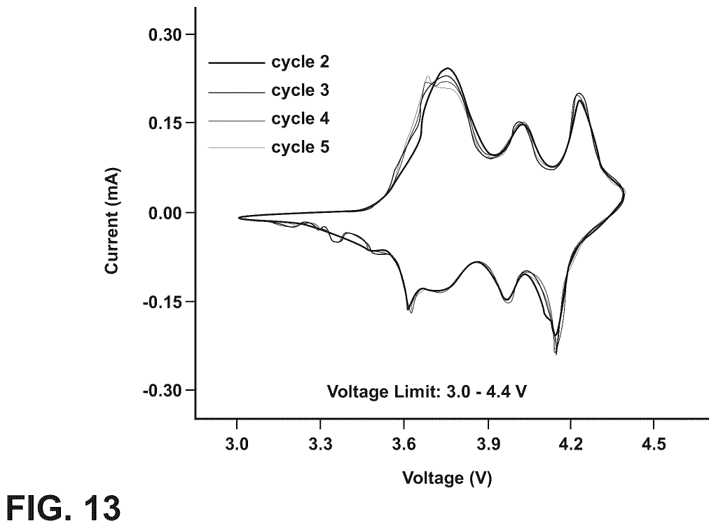

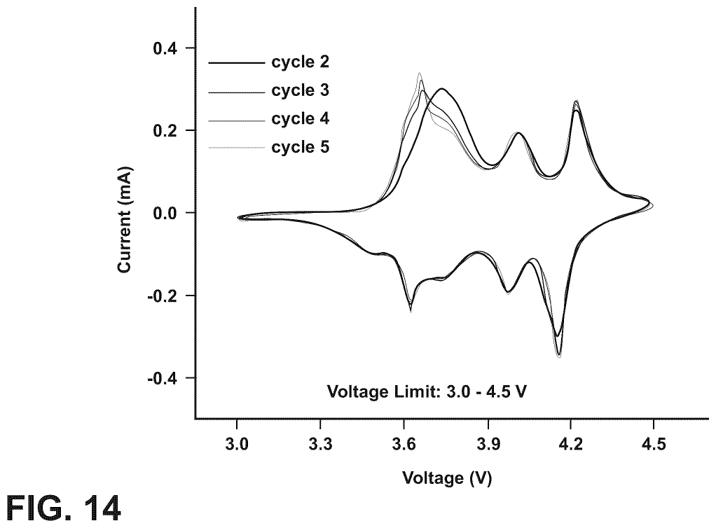

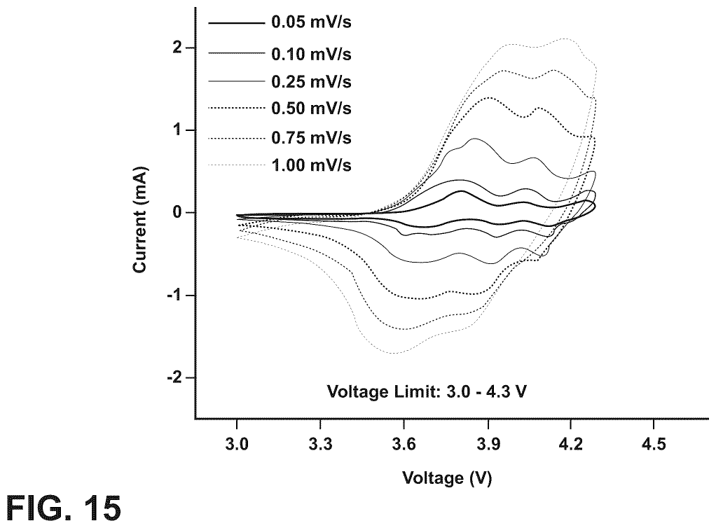

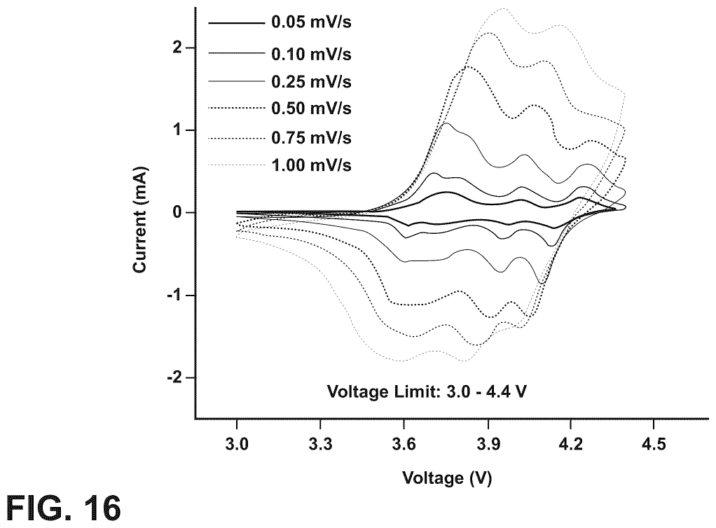

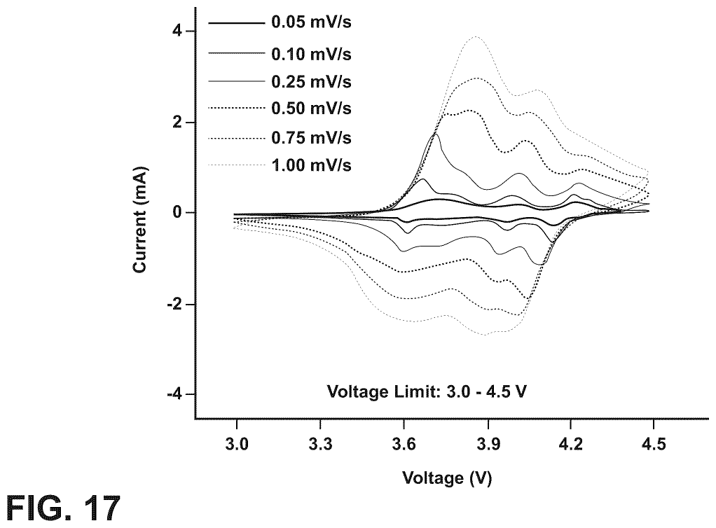

The electrochemical behavior of the NMA9055 cathode material using cyclic voltammetry (CV) is shown in FIGS. 12-17. During the initial CV cycles, three oxidation peaks at 3.77 V, 4.02 V, 4.30 V and three reduction peaks at 3.6 V (with a shoulder at 3.7 V), 3.96 V and 4.10 V were observed. These peaks are assignable to the multiple phase transitions from hexagonal (H1) over monoclinic (M) to hexagonal (H2 and H3) phases. Further, variable scan rate rates of 0.05, 0.1, 0.25, 0.5, 0.75 and 1.0 mV·s⁻¹ were performed from 3.0 V to 4.3 V, 3.0 V to 4.4 V, and 3.0 V to 4.5 V vs. Li⁺/Li. As the scan rate increased, the intensities of the redox peaks increased and the anodic and cathodic peaks shifted to higher and lower potential, respectively. This phenomenon is related to higher polarization in electrodes at higher scan rates.

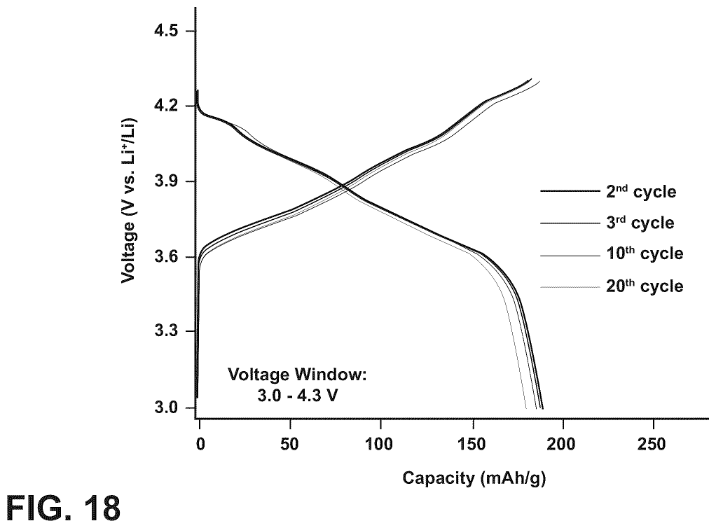

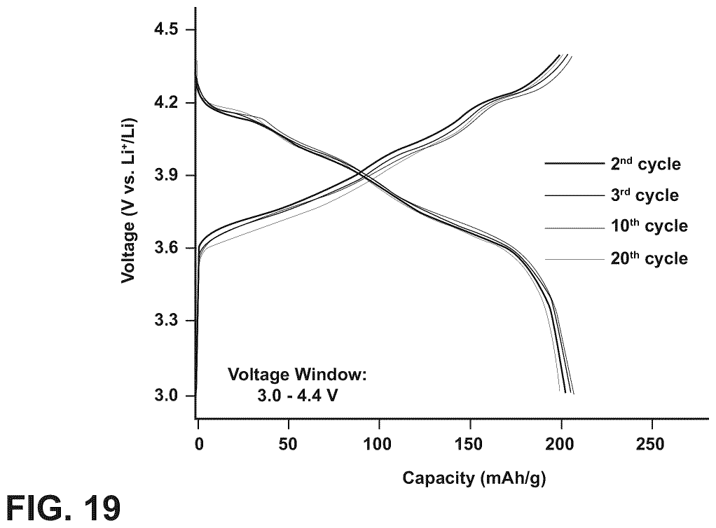

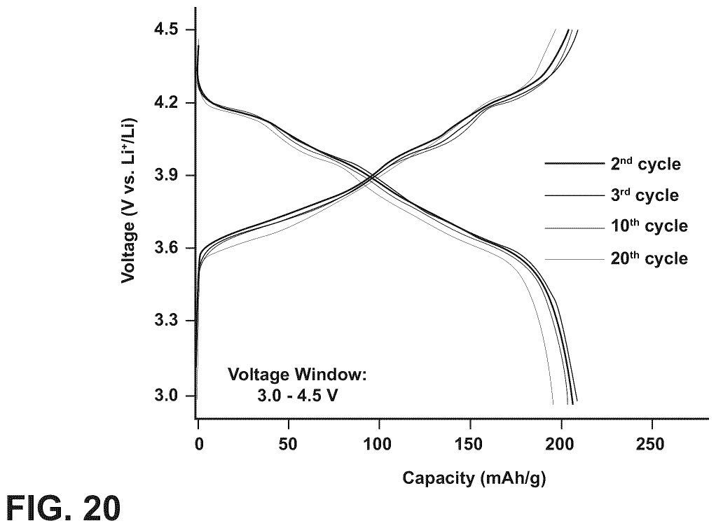

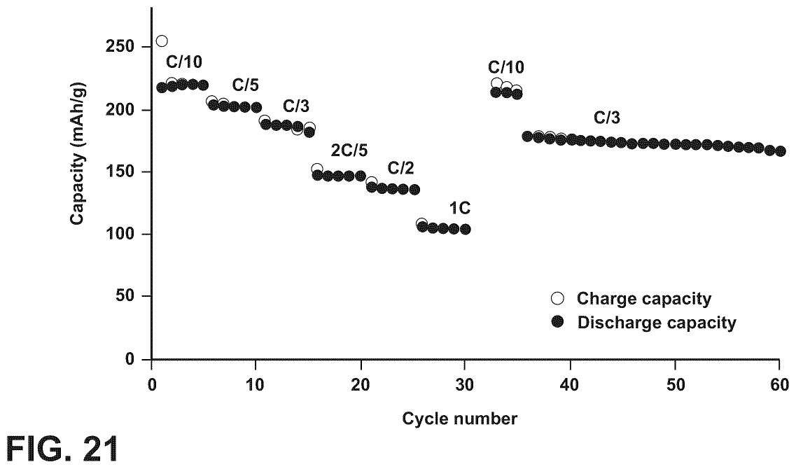

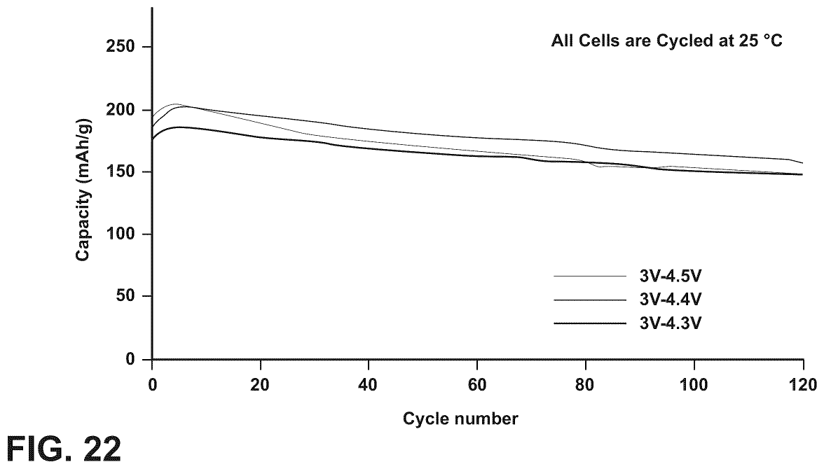

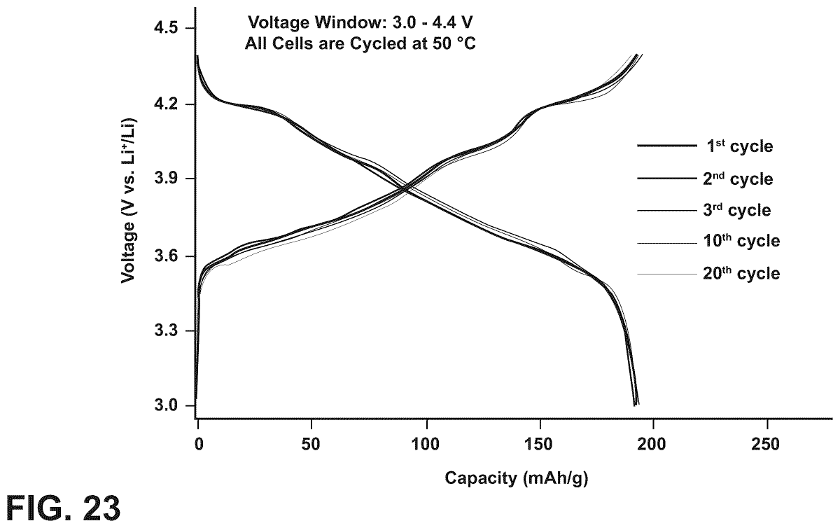

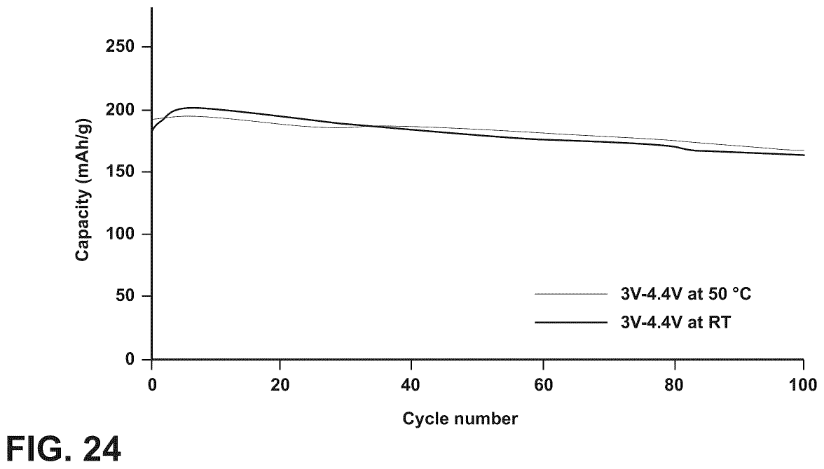

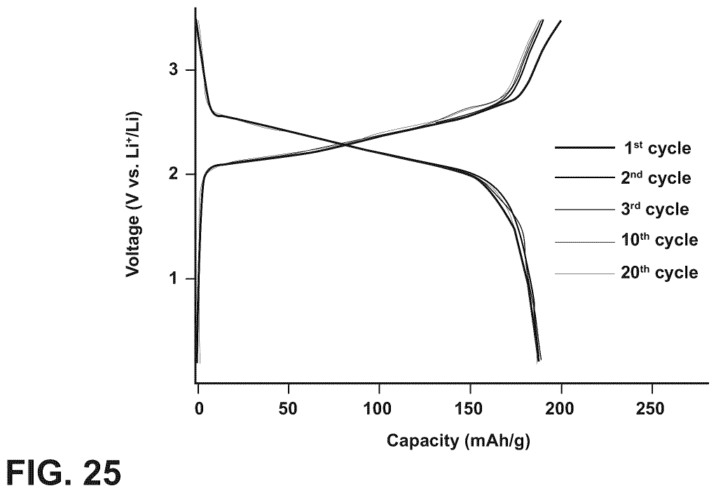

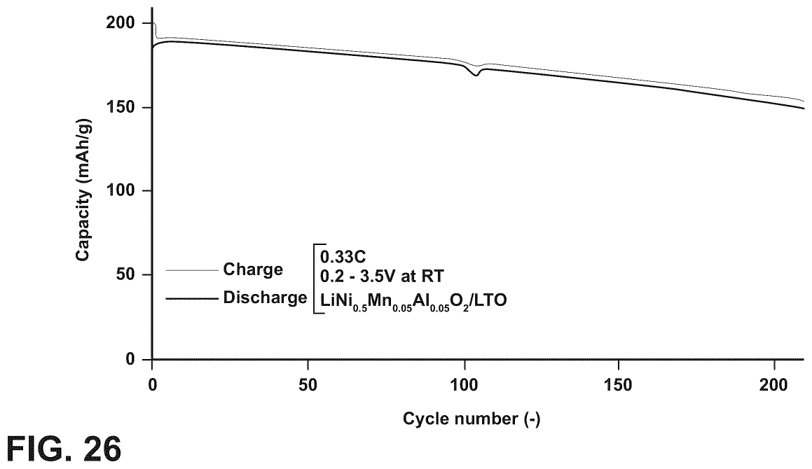

Galvanostatic charge-discharge profiles and long-term cycling performance of the NMA9055 cathode material are shown in FIGS. 18-24. Galvanostatic charge/discharge at a 0.3 C rate were carried out for half-cells cycled between 3.0 V and 4.3 V, between 3.0 V and 4.4 V, and between 3.0 V and 4.5 V. The cell capacity showed a monotonic increase with higher cut-off voltages for the first charge cycle. The cycling performances were markedly different for cells charged and discharged between 3.0 V and 4.3 V, 3.0 V and 4.4 V, and 3.0 V and 4.5 V. The cells charged to 4.4 V retained 91% of the initial capacity, while the cells charged to 4.3 V and 4.5 V retained only 83% and 76% capacity, respectively, after 100 cycles. The rate performance of the NMA9055 cathode was evaluated at 25° C. with 5 cycles at each charge rate, 0.1 C, 0.2 C, 0.3 C, 0.4 C, 0.5 C and 1 C, followed by 0.1 C rate. NMA9055 delivered a discharge capacity of 158 and 111 mAh/g at 0.5 C and 1 C in initial cycles. The NMA9055 cathode was cycled at 50° C. at a 0.3 C rate between 3.0 and 4.4 V to evaluate the high temperature tolerance. The first charge and discharge capacities of this cell was found to be 220 and 191 mAh/g, respectively. 89% capacity retention was observed over 100 cycles. Electrochemical performance of NMA9055-LTO full cells is shown in FIGS. 25-26. The cells were galvanostatic charge-discharged between 3.5 V and 0.2 V at a C-rate of C/3 at room temperature. The first charge and discharge specific capacity at these conditions were 200 and 187 mAh/g, respectively, which is comparable to the half-cell capacity values. Long-term cycling performance analysis showed a high-capacity retention of 81% over 220 cycles.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of forming a cathode material precursor, the method comprising:
dissolving a nickel nitrate hydrate in ethanol to obtain a first mixture;
heating the first mixture at a first temperature for a first period of time; and
cooling the first mixture to obtain a nickel hydroxide hydrate precipitate that is the cathode material precursor;
wherein the first mixture is free of ammonia.

2. The method of claim 1, further including filtering the cooled first mixture to isolate the nickel hydroxide hydrate precipitate.

3. The method of claim 1, wherein the nickel nitrate hydrate is nickel (II) nitrate hexahydrate.

4. The method of claim 1, wherein the cathode material precursor is α-3Ni(OH)₂·2H₂O.

5. The method of claim 1, wherein the step of heating the first mixture is performed in an autoclave.

6. The method of claim 1, wherein the first temperature is in a range of 160° C. and 200° C.

7. The method of claim 1, wherein the first period of time is at least 18 hours.

8. A method of forming a cobalt-free, nickel-rich cathode material for a lithium-ion battery, the method comprising:
dissolving a lithium precursor, an aluminum precursor, and a manganese precursor in ethanol to obtain a second mixture;
adding the cathode material precursor formed by the method of claim 1 to the second mixture to obtain a third mixture;
stirring the third mixture at a second temperature for a second period of time to evaporate the ethanol and to obtain a first powder;
heating the first powder at a third temperature for a third period of time to obtain a second powder; and
heating the second powder at a fourth temperature for a fourth period of time to obtain a third powder that is a lithium-bearing metal oxide.

9. The method of claim 8, wherein the aluminum precursor and the manganese precursor are nitrate precursors.

10. The method of claim 8, wherein the lithium precursor is a hydroxide precursor.

11. The method of claim 8, the method further comprising one of: i) grinding the first powder prior to heating the first powder; ii) grinding the second powder prior to heating the second powder; or iii) both i) and ii).

12. The method of claim 8, wherein the fourth temperature is greater than the third temperature.

13. The method of claim 8, wherein the fourth period of time is greater than the third period of time.

14. The method of claim 8, wherein the second temperature is in a range of 35° C. and 45° C.

15. The method of claim 8, wherein the third powder is LiNi_{0.9}Mn_{0.05}Al_{0.05} O₂.

16. A cobalt-free, nickel-rich cathode material formed by the method of claim 8.

17. A lithium-ion battery comprising the cobalt-free, nickel-rich cathode material of claim 16.

18. A method of forming a cobalt-free, nickel-rich cathode material for a lithium-ion battery, the method comprising:
ethanol-assisted, hydrothermal synthesis of a cathode precursor by ethanol oxidation without the presence of ammonia, the hydrothermal synthesis including:
dissolving nickel (II) nitrate hexahydrate in ethanol to obtain a first solution;
heating the first solution at a first temperature for a first period of time;
cooling the first solution; and
filtering the cooled solution to obtain the cathode material precursor that is α-3Ni(OH)₂·2H₂O;
subsequent to synthesizing the cathode material precursor, performing synthesis of a lithium-bearing metal oxide, the synthesis including:
dissolving LiOH·H₂O, Al(NO₃)₃·9H₂O, and Mn(NO₃)₃·9H₂O in ethanol to obtain a second solution;
adding the α-3Ni(OH)₂·2H₂O cathode material to the second solution to obtain a third solution;
stirring the third solution at a second temperature for a second period of time to obtain a first powder;
grinding the first powder followed by heating the first powder at a third temperature for a third period of time to obtain a second powder; and
grinding the second powder followed by annealing the second powder at a fourth temperature for a fourth period of time to obtain the lithium-bearing metal oxide powder.

19. The method of claim 18, wherein the lithium-bearing metal oxide powder is LiNi_{0.9}Mn_{0.05}Al_{0.05} O₂.

20. A lithium-ion battery cathode comprising the cobalt-free, nickel-rich cathode material formed by the method of claim 18.
